(19) United States
(12) Patent Application Publication
(10) Pub. No.: US 2005/0129385 A1
(43) Pub. Date: Jun. 16, 2005

(54) Intelligent portable memory device with display

(75) Inventors: Jerry A. Speasl, Pleasanton, CA (US); Zona F. Speasl, Pleasanton, CA (US); Marc K. Roberts, Huntington Beach, CA (US)

Correspondence Address: HAYNES BEFFEL & WOLFELD LLP, P O BOX 366, HALF MOON BAY, CA, 94019, US

(73) Assignee: JMZ LLC

(21) Appl. No.: 10/663,183

(22) Filed: Sep. 16, 2003

(51) Int. Cl. H04N 5/76

(52) U.S. Cl. 386/46

(57) ABSTRACT

Roughly described, a portable, removable memory device also includes a display for rendering images stored in the memory device in standalone mode. The memory device has a standard attachment interface to enable attachment and communication with different kinds of hosts. It also includes at least sufficient intelligence to be able to transform image file formats to satisfy user preferences or the requirements of different hosts. The device can be used as an interchangeable memory card, and also as a simple and easy way of sharing digital images.

### FIELD OF THE INVENTION

The invention relates to a self contained, flexible, highly portable storage transfer and display system with methods of incorporating long-term storage, display of digital video or digital still images taken with digital cameras, either still or video, or other digital image systems including, but not limited to, cellular phones, PDA's, Web cameras, banking systems (ATM), ticket systems, security systems, WWW information systems, and digital camera systems having remote image transmission capabilities.

### BACKGROUND

Digital photographers and videographers, whether amateur or professional, are taking more digital photographs and videos than ever. This is due, in part, to the advances made with digital cameras that permit hundreds or thousands of images to be captured in removable digital memory.

Today's video and still digital cameras can use one or more of a variety of removable memory media including Compact Flash, Smart Media, SD-Memory, Ultra Drive, and Memory Stick to name a few. The storage capacity of these devices ranges from a few megabytes to more than four gigabytes. The higher storage capacities permit several hundred to tens of thousand of still digital photographs or video clips to be captured and stored without having to stop and install a new, empty storage device such as with a traditional analog film camera.

Display devices for both digital and video cameras serve as both a viewfinder, aiding the photographer or videographer in setting-up the shot, and as a playback device for directly viewing the images or videos stored in the memory device. But since on-camera displays are usually small, they are inconvenient for sharing images and videos with others. In order to share, photographers and videographers either must upload their work via an electronic wired or wireless link to another “sharing device”, such as a computer, PDA or printer, or must remove the memory storage device from the camera and install it into the sharing device. All of these sharing methods require the use of an additional device, which can be an expensive addition to a camera and which, at least for computers and printers, is often larger and bulkier than the camera itself. Wired and wireless transfers also usually require the camera and the sharing device to be physically near each other, and wired transfers require the use of a cable which is susceptible to becoming tangled or misplaced. Removal of the memory device and its insertion into the sharing device avoids some inadequacies of electronic transfers, but introduces new problems instead: many of today's removable memory devices are small and easily misplaced or mixed up with others, and once one has been removed from the camera, it is impossible to determine what images it contains until it is re-inserted into a compatible camera or into a sharing device.

It would be desirable to be able to instantly share digital photographs and video clips as easily as one conventionally shares a photo print, such as a Polaroid picture, but without the paper or chemicals: the image develops instantly, it is immediately removable from the camera, it is immediately viewable without any additional machinery, it is easily sharable with friends and business associates, and it is small and light enough to be carried around in a shirt pocket. Moreover, it would be desirable for the image sharing mechanism to take advantage of the power afforded by digital rather than photographic storage of images, such as storing a large number of images or video clips in a small physical space, by including slide show functionality and certain image processing functionality, and by permitting insertion in or electrical attachment to other digital devices (such as a computer, PDA or printer) for further increased functionality. Such flexibility and ease-of-use is not available today in any commercial system.

U.S. Pat. No. 4,887,161, incorporated by reference herein, describes a memory cartridge that is removable from a digital camera and includes a display for viewing images in the memory while the cartridge is separate from the camera. But this cartridge also acts as the camera's viewfinder while it is inserted in the camera, and that may not be desirable in all circumstances. Also, once the cartridge is removed from the camera the camera can no longer function on its own. In addition, the cartridge cannot be used in other digital devices, apart from the camera, and it does not appear that this cartridge can perform certain image processing functions (such as image file format conversion) that may be necessary for utilization with various kinds of digital devices.

### SUMMARY OF THE INVENTION

The present invention, in one broad aspect roughly described, is an improved highly portable digital memory device with an integrated, fully portable display system that permits digital photographers and videographers to immediately share images with others in any environment by simply removing the device from the digital camera and viewing the stored set of images directly on the integrated display. The same device also performs the functions of a conventional removable memory device, since it can include sufficient memory to store a large number of photographs or video clips, and has a standard interface that allows bidirectional connections to a variety of different kinds of hosts at different times. In addition, the device also includes a controller which is operable to, among other things, transforming the file format in which an image is stored in the on-board memory so as to interface more flexibly with different kinds of hosts.

In various embodiments, the operator can perform several functions directly with the portable memory device including, but not limited to: directly view stored images, organize the image/file ordering, delete image files, scroll, view, organize via thumbnail images, control brightness and contrast, set/adjust the time and date, set viewing rights for image files, copy, duplicate, edit, download from internet, cell phone, PDA or other portable device, and more. One could operate the portable memory device in accordance with the viewing rights established by the image file originator through the control function or embedded software features. Additionally, the user can identify specific software applications to be loaded onto the portable memory device and executed, such as “Power Point”, “Microsoft Photo Album”, “Windows Picture and Fax Viewer”, to name a few. The portable memory device can assume many physical form factors as the architecture is scalable but the preferred embodiment will fit in your hand for easy sharing, or in a shirt pocket, purse, wallet, or desktop intelligent cradle system capable of interfacing with a multitude of electronic devices to transfer and exchange image files. The intelligent cradle system, in a static state, provides backup power through a set of contact pins located on the rear or bottom of the device.

In consumer applications, there is a craving to immediately view still images and video footage to share both individually and also communally without the camera. In preferred embodiments, this implementation of the invention includes a small form factor such as the popular Compact Flash (36×43 millimeters), a thin film OLED type of display screen, an integrated power source such as NiMH or Li-Ion or other power source, and means for selecting, retrieving, and displaying the contents of the storage device. User interface controls incorporating either touch-screen controls or mechanical controls, and headphones for listening to any audio components associated with the image or video, permit an individual to directly view and listen to the contents of the storage device in a “standalone” mode without the “host”-attachment requirements associated with other memory storage devices. The small form factor facilitates portability because several will fit into a shirt pocket, wallet, purse, or briefcase. In an alternative embodiment, a re-loadable multi-card holder such as a magazine capable of storing several portable memory devices is embedded into a camera permitting the operator to continue capturing images or video beyond the storage capacity of a single memory device, or alternatively, to remove the display/memory device and have several more to use. Finally, because of the small size and technologies available for incorporation with this invention, the device can be made very rugged and durable, able to withstand severe handling and treatment of handheld consumer devices such as falling onto hard surfaces or submersion into various liquids.

For professional applications, there is a similar need to share digital images, video clips, and presentations often in informal settings such as trains, planes, hallways, restaurants and other spatially confined environments. A professional user might copy the necessary digital images for a potential meeting or meetings onto the device from multiple sources such as a digital camera, digital video camcorder, desktop or laptop PC, or the Internet. When opportunities for meetings occur, the professional user has all of the necessary data available for presentation to others to facilitate a successful outcome. Collaboration can be accomplished by simply handing the device to the meeting participants for subsequent dialogue with their colleagues or for copying onto their PC, docking stations, or other display devices, for further study and commentary.

A device according to the invention is conceived to be considerably more intelligent than a simple display removable from a digital camera host, as evidenced by its minimum on-board ability to transform image file formats. In one embodiment the device is further able to determine automatically any image file format requirements imposed by the current host. In another embodiment the device includes a general purpose processor that operates in accordance with a stored program. Additional or replacement software can be downloaded to the program memory on the device in order to improve existing functionality or add new functionality. Still other embodiments can support audio capabilities (such as by including one or more speakers on the device), display of documents and email, speech articulation, or speech recognition for user control of the device. Another embodiment includes a GPS receiver and dynamically generates a local map for the display. Many other features can be included in various embodiments.

### BRIEF DESCRIPTION OF THE DRAWINGS

The invention will be described with respect to specific embodiments thereof, and reference will be made to the drawings, in which:

FIGS. 1 and 8 are a functional block diagrams of portable memory devices according to an embodiment of the invention.

FIG. 2 illustrates a portable memory device incorporating features of the invention, and several additional devices to which the portable memory device can be attached.

FIG. 3 is a flowchart illustrating various steps that a user can perform using the devices of FIG. 2.

FIGS. 4, 5 and 6 are top views of example hosts in which the portable memory device of FIG. 2 can be inserted.

FIGS. 7 and 10 depict other portable memory devices incorporating features of the invention.

FIG. 9 depicts a block diagram of a desktop power cradle that can be used with a portable memory device.

### DETAILED DESCRIPTION

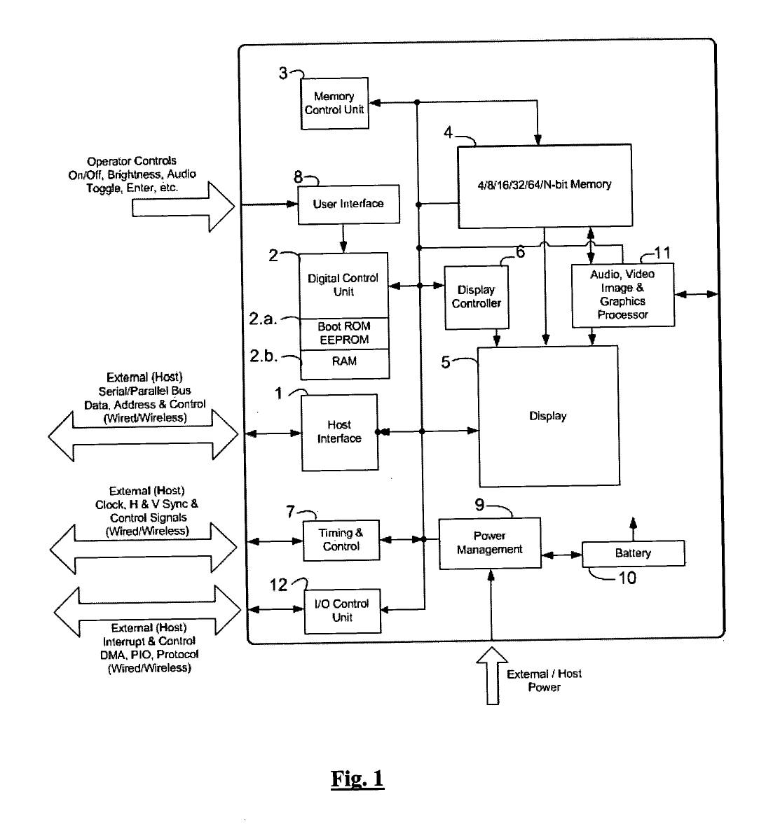

FIG. 1 is a functional block diagram of a portable memory device according to an embodiment of the invention. The device functions differently depending on whether it is attached to a host device such as a digital camera, digital camcorder, PDA, PC, or being used as a standalone viewing device.

When attached to a host device such as digital camera, the device is under the command of the host. The Digital Control Unit 2, is passive and only performs system health monitoring. Display data is transmitted from the host (example: digital camera) to the display 5 via the Host Interface 1. Display 5 can be any display such as LCD, LED, or OLED to name a few. Preferably it is a lightweight display. It can also be an interactive touch screen, or stylus/pen so that it can also act as a user input mechanism. In a preferred embodiment, an OLED display is used because it offers the benefit of low power consumption with excellent luminance, contrast and viewing angle performance in addition to being lightweight and offering physical flexibility (i.e., non-rigid).

Image data from the host (such as a digital camera) can be displayed, stored in memory, or both, by sending instructions to the Display Controller 6 and Memory Control Unit 3. Upon receiving commands from the host, the Memory Control Unit 3 determines the address within the Memory 4 and manages the storage operation. Memory 4 can be any type of digital memory including static, dynamic, flash, optical, magnetic, or atomic to name a few. In a preferred embodiment, a flash type of memory device incorporating multi-layer cell (MLC) technology is used for storage capacities in excess of 4 Gigabytes. The host device can select specific images for display by sending the appropriate command to Memory Control Unit 3 and Display Controller 6 via Host Interface 1. The Memory Control Unit 3 retrieves the image from the appropriate memory addresses and sends it to Display 5. Display Controller 6 manages the display operations. Alternatively, a video clip can be displayed by sending the appropriate commands to Audio, Video, Image & Graphics Processor 11 and Memory Control Unit 3, which then identifies the range of addresses where the video clip was stored and begin transmitting the data to processor 11. Processor 11 sends individual frame information to Display 5, frame by frame. In an alternative embodiment, an external output can be provided to permit connection to an external display device such as a large plasma, LCD or CRT screen, television monitor, or other communal viewing apparatus.

An alternative embodiment of the invention involves the use of a non-camera host for originating images, such as a laptop PC, PDA, or other PC device. In this embodiment, video or images can be transferred from the host device to the memory /display which can then be removed and utilized similarly to a conventional handheld MP3 music player. The portable device, acting as a memory storage device, can be inserted into any compatible standards-based PC card slot such as a PCMCIA connector, for example. Control of the display/memory device is directed by the host via I/O Control Unit 12. Timing and synchronization between the device and the host is accomplished via Timing and Control Unit 7. Data and address information is passed from the host to the device via Host Interface 1.

Yet another embodiment of the invention involves attachment to a host device via a cable such as a USB or 1394 Firewire. The device's I/O Control Unit 12 detects the attachment method and signals Digital Control Unit 2 for the appropriate instruction set. The Digital Control Unit 2 then configures the Host Interface Unit 1, Timing & Control Unit 7, and Power Management Unit 9 appropriately.

When operated standalone, the portable memory device is operated by the user via User Interface 8. Typical embodiments include a power “On/Off” switch, a display “brightness” and “Contrast” control, a selection switch such as a “toggle (Up/Down, etc.)” and “Select” switch to name a few. In a preferred embodiment, an audio jack is provided and controlled by Processor 11 so that the audio portion of a video clip, or audio commentary accompanying a still image, can be heard via head phones or a speaker. Alternatively or additionally, one or more flat speakers can be incorporated directly into the portable device.

In the standalone mode, the User Interface 8 interprets operator instructions and provides the appropriate commands to the Digital Control Unit 2. Digital Control Unit 2 can be any microprocessor or controller, configured as a single or multiprocessor/memory arrangement. In one embodiment, a RISC processor such as an ARM processor is used. Routines, instruction sets, or programs are executed that were stored a-priori in the Boot ROM/EEPROM Memory 2.a. Random access memory, RAM 2.b., is used by the DCU 2 to carry out the numerous instructions and operations resident in Boot ROM/EEPROM 2.a. From time-to-time, it may be necessary to update or modify the instructions or command sets resident in Boot ROM/EEPROM 2.a. The EEPROM feature of the invention allows for the incorporation of updates or modifications or new application software, as may be desired or necessary to accommodate new imaging functionality, file management, or operator usage. The Boot ROM/EEPROM as well as the RAM functionality may be either embedded or attached to the Digital Control Unit 2.

In standalone mode, the Host Interface 1 is non-functional until the device is, once again, attached to a host device. External timing and control signals are not present for synchronization and are generated internally by Timing & Control Unit 7. Power Management Unit 9 detects whether the device is connected to an external power source or if internal Battery 10 power must be utilized. When connected to a host, the Power Management Unit 9 conditions the external power for device use and, in certain embodiments of the present invention, uses a portion of the external power to recharge the device's Battery 10, if rechargeable. Alternatively, an external power source such as an AC power adapter, or solar source, may be used when using the device standalone in lieu of the internal Battery 10.

As mentioned, a device according to the invention can carry significant intelligence, as evidenced by, at a minimum, an on-board ability to transform image file formats. As used herein, an “image file format” refers to formats such as, but not limited to, JPEG, GIF, TIFF, PICT, MPEG, XIF and BMP, for example; not whether or not an image in one of such formats is further compressed, or encoded or packaged for transmission or storage. In one embodiment, the digital control unit 2 (FIG. 1) includes at least one microprocessor or controller but may also contain several processors or controllers, hardware or software, each performing specific instructions or command sets. Alternatively, one or more of the processors/controllers may serve as redundant backups in the event of a primary processor failure. The resources of the digital control unit 2 are used to perform image file format transformations using conventional algorithms. In another embodiment, the microprocessor(s) and/or controller(s) are contained within host interface 1, and perform the same functions just described. These processors/controllers not only facilitate the transfer and routing of data between the host and the portable memory device 210, but also examine the metadata of incoming data files in order to identify incoming data file formats. As used herein, the term “controller” includes all the processing units involved in performing processing functions on the portable memory device, including those involved in image file format conversion, and including any general purpose processor.

Combining microprocessors/controllers is well known to those skilled in the art. In one implementation, all microprocessors/controllers share common data and address lines. One area of complexity that arises is in the establishment of a logical arbitration hierarchy. This problem may be resolved by having one microprocessor or controller control initiation of the second or subsequent processor and, when complete, regain control. This can be performed via hard-wired or software, instruction/command set driven, means. A multi-processor /controller architecture provides speed and convenience: it provides speed because the file formatting process can occur in parallel to other operations occurring within the memory device 210, and it provides convenience because the file can be transformed to a user selected format for use in a subsequent user application in an external Host device.

Because of the intelligence available in the portable memory device, embodiments of the device can also be used to add functionality to a host to which it is attached. This functionality can include, for example, image processing, editing, file format conversion, file management, playback, display, narration, and transmission to name a few. For example, in one embodiment, a digital camera host, lacking video capture capability but possessing a multi-shot modality can, utilizing the processing power inherent to the memory display device, can produce video files. Referring to FIG. 1, sequential image data received via the host interface 1 can be routed to the memory 4 whereupon it is stored temporarily until all sequential image frames are received. Under command of the digital control unit 2, conversion to the format selected a priori by the user via the user interface 8 is performed either by software control means stored in the EEPROM and/or RAM 2a or 2b, and executed by the digital control unit 2; or by a specific video processor 11. The resultant video file, formatted to user selection, is then stored in memory 4 from which it can be viewed, edited, renamed, deleted or simply stored for use later.

Similarly, in another embodiment, the memory display device might be connected to a personal video recorder (PVR) host device where it is being used as storage for a video program. Following host removal, the user may decide to view the stored video. The user may further decide to freeze or capture a single frame of the video program for an e-mail. The user does so by selecting the ‘capture’ feature displayed on the memory display device display 5 via the display controller 6. Sensing the user selection on the touch screen display 5, the display controller relays this command to the user interface 8 which, in turn, causes the digital control unit 2 to access the associated control logic or algorithm needed to perform the frame capture command. Following retrieval of the commands list or algorithm from the EEPROM 2a by the digital control unit 2, the image frame displayed at the time of operator selection is retrieved from memory 4 and a user prompt is displayed asking the user for a name for the new file.

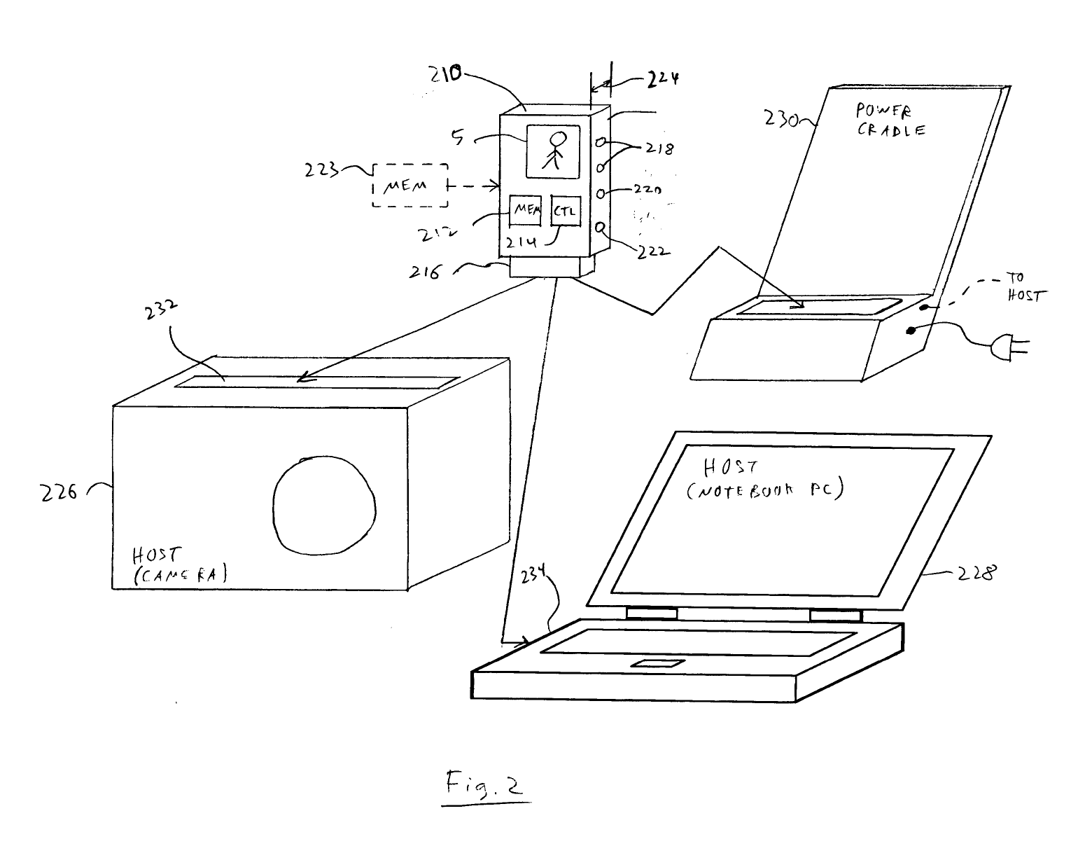

FIG. 2 illustrates a portable memory device 210 incorporating features of the invention, and several additional devices to which the portable memory device 210 can be attached. The portable memory device 210 includes all of the features illustrated in FIG. 1, including but not limited to the display 5, and memory 212. The memory 212 in FIG. 2 corresponds to both the boot ROM 2.a. and the RAM 2.b. collectively, of FIG. 1. All the various control functions illustrated in FIG. 1 are collected for illustration purposes in the control unit 214 of FIG. 2. The device also includes a battery or other power source, not shown, such as an ultra-thin, flexible battery available from Power Paper Ltd, Einat, Israel.

The portable memory device also includes connector 216, which has a standardized mechanical structure for mating with a corresponding connector on hosts or other devices to which the portable memory device 210 can be attached. In various embodiments, the device 210 can also include one or more control switches or buttons 218, a flat speaker (not shown), a headphone jack 220, and/or a separate data connector 222. In an embodiment, the portable memory device 210 can also include a slot for its own removable conventional memory card 223, which is also considered herein to be included within the memory 212 illustrated in FIG. 2.

The portable memory device 210 is unitary in structure, in the sense that it is not constructed of separate pieces that are connected together wirelessly or by a flexible wire. All of its components are supported on a substrate, such as a printed circuit board or a housing. The device can be made either rigid or flexible in various embodiments. Preferably the device 210 is small and thin enough to be carried around in a shirt pocket. The device should in particular be thin enough to fit within various slots as described hereinafter, and for marketing purposes it is advantageous for the device to be of a size that users generally associate with familiar portable memory devices or familiar PCMCIA or SmartMedia devices. The PCMCIA standards organization specifies the thickness of Type I and Type II PC Cards as 3.3 and 5.0 mm, respectively. See PCMCIA, “PC Card Technology Primer” (1998), incorporated by reference herein. The SSFDC Forum specifies the thickness of SmartMedia cards as 0.76 mm. See SSFDC Forum, “Features and Specifications of SmartMedia” (2003), incorporated by reference herein.

For these reasons, it is preferred that the device 210 has a thickness 224, which does not exceed 10.5 mm. Stated more precisely, the portable memory device preferably fits within a “bounding box” having first and second parallel surfaces separated by no more than 10.5 mm. Preferably, in fact, the first and second parallel surfaces are separated by no more than 5.0 mm, or even 0.76 mm. As used herein, a bounding box is a hypothetical solid having six rectangular surfaces. In order to “fit” within a bounding box, the entire device, including all protrusions, must fit within the box. Protrusions that increase a dimension but are collapsible or retractable to fit entirely within the box are allowed, because the device still “fits” within the bounding box, although some action may be required to make it fit.

The portable memory device 210 is operable either in a stand-alone mode or in a mode in which it is attached to a host. Two potential hosts are shown in FIG. 2, a digital camera 226 and a notebook PC 228. Other potential hosts include PDAs, cell phones, set-top boxes, TiVo devices, and so on. The digital camera 226 can be, for example, either a still image camera, a moving image camera, or a combination still and moving image camera, and can also include other functions such as sound recording.

Device 210 can operate in either a “peer-to-peer” or “command-slave” mode depending on the host device and associated protocols. For example, attaching device 210 to PC 228 would likely be a “command-slave” connection utilizing Home API (HAPI) protocols—device 210 would be controlled by PC 228. Alternately, attaching device 210 to digital camera 226 could be either a “peer-to-peer” or “command-slave” connection but more likely a “peer-to-peer” utilizing Home AVI (HAVI) protocols: HAVI protocols permit either device connected to each other to operate autonomously. The portable memory device 210 can automatically detect the type of host connection and modality, and interact with the host accordingly.

The portable memory device 210 operates with respect to various hosts similarly to the way other conventional removable memory devices operate, in the sense that while connected to the host, the host can read or write images and/or other data from or two the memory 212 on the device 210, and in the sense that the device 210 retains the images and/or other data upon removal from the host. The device 210 can then be connected to another host, potentially a completely different type of host, and the new host will have access to the same memory 212 on the device 210. A basic goal of the device 210 is to simplify the sharing of image-based information, and consistently with that goal, most hosts with which the device are used are physically larger than the device 210 itself. The device 210 can be removed from the host and shared, an activity that might be difficult with a larger, bulkier or typically more expensive host device. Nevertheless, some hosts, for example a miniature CCD camera, can be smaller than the device 210.

FIG. 2 also shows a power cradle 230 to which the device 210 can be attached. But as used herein, such a power cradle is not itself considered to constitute “host”. At most, such a cradle might be considered a tether to a host.

The connector 216 on the device 210 is part of a communication interface that has at least two levels of definition: a mechanical definition and a communications link definition. The communications link definition itself includes at least a physical layer definition (such as an electrical definition) and one or more communications protocol layers. Mechanically, the communications interface preferably includes a rigid connector, although a flexible connector such as a flexible wire also can suffice. The communications interface can also be wireless, including RF, magnetic or infrared communications mechanisms. In the case of the rigid connector 216, edge card connectors or rigid multipin connectors can suffice.

In the embodiments illustrated in FIG. 2, the portable device 210 attaches to hosts 226 and 228 by insertion into a slot 232 or 234, respectively, in much the same way as a conventional memory card inserts into a slot. In one embodiment the connector 216 is a multipin connector conforming to the PCMCIA specifications. An advantage of using the PCMCIA specification for the rigid connector 216 is that it is already defined, standardized and well-known in both its mechanical and electrical layers, and also to some extent in its protocol layers. Alternatively, it may conform to another standard specification, such as the upcoming Newcard specification. In the case of a wireless communications link or a communication link using a flexible wire, the mechanical aspect of the communication interface might simply be a hook-and-loop physical attachment arrangement. In some embodiments, the mechanical attachment itself enables the communication link, which is the case with rigid mechanical/electrical connectors, for example. In other embodiments, such as in the hook-and-loop arrangement, the mechanical attachment is independent of the communication link.

While the portable memory device 210 is operating in a standalone mode, it can be controlled by the user with a number of different control features in various embodiments. In one embodiment, the user controls the operation of the device using the buttons and switches 218. In another embodiment, a remote control is used. In still another embodiment, the display 5 is a touch screen, and the user can control the device via the touch screen. In yet another embodiment, the device 210 includes or is connected to a microphone, and incorporates speech-recognition capability for receiving and decoding user voice commands. The speech-recognition embodiment is particularly advantageous where the small size of the memory device 210 renders a mechanical user interface cumbersome. Many other user interface mechanisms are possible and will be apparent to the reader.

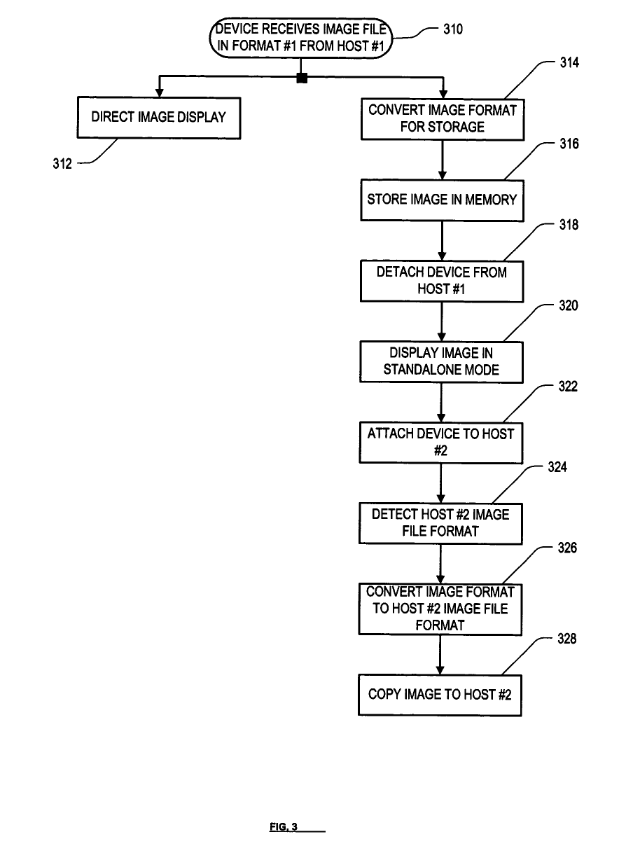

FIG. 3 is a flowchart illustrating various steps that the user can perform using the device 210. In a step 310, while the device 210 is connected to a first host (such as having been inserted in digital camera 226), the device receives an image file in a first format from the first host. In a mode of operation available in one embodiment, the controller 214 passes the image directly to the display 5, bypassing the memory 212 (step 312). In this mode the device 210 can act as a viewfinder or image previewer for the first host device. In another mode of operation, the controller 214 can store the image into memory 212, either additionally to or instead of the direct image display step 312.

When images are downloaded into the portable memory device 210 in step 310, in one embodiment the originating host can specify a sequence in which the images are to be displayed. In various embodiments, the specified sequence applies either only while the portable memory device 210 is connected to the first host, or only while the portable memory device 210 is operating standalone, or in both situations. In one embodiment the display sequence is specified via commands predefined in a protocol layer of the communications interface. In another embodiment the display sequence is specified in meta-data associated with one or more of the image files.

If the incoming image is to be stored into memory 212, then control unit 214 optionally first converts the incoming image format to a native image format for the device 210, or to some other preferred image format (step 314). In an embodiment, in order to establish the incoming data file format, the portable memory device 210 examines metadata in the incoming data file and compares it to a known list of file formats. The device 210 also examines user selected preferences, if any, and then automatically reformats the incoming data file into the desired format using conventional image file format conversion algorithms. In the absence of user selected format preferences, the memory device 210 can be programmed to store the data in the native format that it possessed at the time of transfer from the first host device. Alternatively, another embodiment is programmed to format the data into a single default format chosen a priori by the manufacturer.

In step 316, the image file is stored in memory 212. Many images can be stored in this manner, including moving images, slide shows, and so on. Other data can be stored in this manner as well, as described elsewhere herein.

In step 318 the device 210 is removed from the first host, much as a conventional removable memory card is removed from its first host. Unlike the removable memory card, however, in step 320, the user can display one or more of the stored images in a standalone mode on the display 5. Thus the images on the device 210 can be shared with others simply by handing them the device, much like the way Polaroid pictures and photo prints can be shared among friends and associates.

During step 320, while the portable device 210 is operating in standalone mode, the user can operate the controls (in whatever form they might be provided) to display the stored images either in a forward or reverse sequence, or randomly, or according to some other specified sequence such as by date and time, author or source, subject, or size for example. The user can also control brightness, contrast and color. Many other kinds of user control can be provided depending on the capabilities of the device 210. The user can also perform various file management functions of renaming, deleting and editing, or adding text or graphics. In some embodiments, the user can cause the portable memory device 210 to transform image file formats of one or more images in the memory 212 while operating standalone. In this situation, both the source and destination files of the image file format transformation are within the memory 212. These image data files have with them their associated file location tags, time/date, and numbering sequence. Likewise, the audio file manager coordinates the location and association with each image file location.

As used herein, all user input concludes, at one point or another, a “user-commit” action. For a one-touched command, like a shutter release, user activation of the shutter release also indicates a user commit. For multistep process, such as manually setting a destination image file format for downloading to host, followed by the downloading operation, the series of commands will end with a user-commit action of some kind.

In step 322, the device 210 is attached to a second host optionally different from the first host. In step 324, in one embodiment, the device 210 automatically detects a desired image format for the second host, and in step 326, the controller 214 converts an image file from memory 212 into that image file format. In step 328 the optionally converted image is copied to the second host.

Automatic detection of a destination image file format in step 324 typically involves interrogation of the current host for a desired image file format. Such interrogation can take place according to a command defined in the protocol layer of the communications interface. In another embodiment, the device 210 interrogates the current host device for unique identification data such as model number, serial number, operating system or manufacturer. Subsequent data transfers between the device 210 and this specific host device then result in derived format preferences for this specific host device which, when encountered again in the future, are invoked automatically.

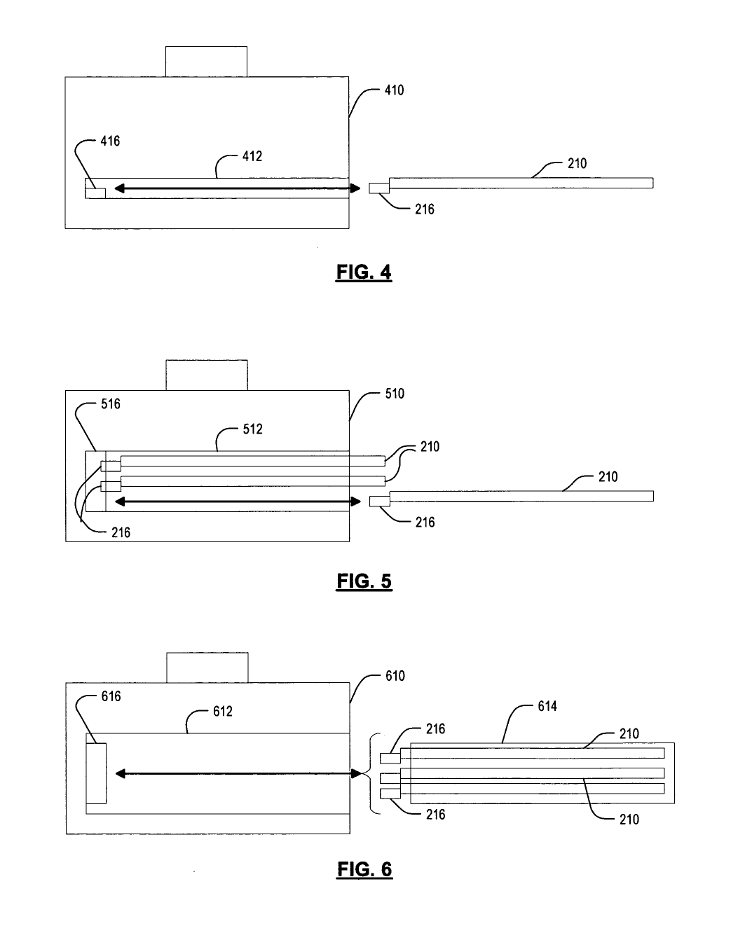

FIG. 4 is a top view of an example host, in particular a digital camera 410, in which attachment of the portable memory device 210 to the host 410 involves insertion of the portable memory device 210 into a slot 412 in the host 410. When the device 210 is fully inserted into the slot 412, the connector 216 makes positive electrical contact with a corresponding mating connector 416 at the inner end of the slot 412. Pushbutton ejection can be added in various embodiments, with our without spring loading.

FIG. 5 is a top view of another example host, again a digital camera 510, in which a slot 512 is wide enough to accept multiple (in this case three) portable memory devices 210 at the same time. Each of the three portable memory devices 210 includes its own rigid connector 216, and all three connectors 216 mate with a common connector 516 at the inner end of slot 512. In the embodiment of FIG. 5, therefore, all of the portable memory devices 210 are connected at the same time to the host 510. In one embodiment utilizing the structure of FIG. 5, only one of the inserted memory devices 210 (for example whichever device is front-most in the camera 510) is active at any given time. If the front-most device 210 is removed from the camera 510, then the next device 210 automatically becomes the front-most device and therefore the active device. Alternatively, the host 5 10 can determine for itself whether the currently active device is full or nearly full, and automatically select the next device 210 to be the new active device. In another embodiment, the user can select which one or more of the three then-inserted memory devices 210 is (are) to receive each image or other data file. In yet another embodiment, not shown, the connector in the host 510 is arranged such that only one of the inserted memory devices 210 makes electrical contact with the pins on the host connector at a time. That memory device 210 is the active memory device, and when it is removed, the next device 210 either automatically or manually moves into place to make electrical connection with the host connector.

FIG. 6 is a top view of yet another example host 610, which includes a slot 612 for accepting a cartridge 614 of portable memory devices 210. The cartridge 614 contains a plurality of the devices 210 (three shown in FIG. 6), each with its own connector 216 extending out of the cartridge 614. When the cartridge 614 is outside the body of host 610, individual portable memory devices 210 can be inserted and removed from the cartridge 614. When the cartridge 614 is inserted into the slot 612, all of the connectors 216 make positive electrical contact with the mating connector 616 at the inner end of the slot 612. All the variations discussed above with respect to FIG. 5 can be used as well in the embodiment of FIG. 6.

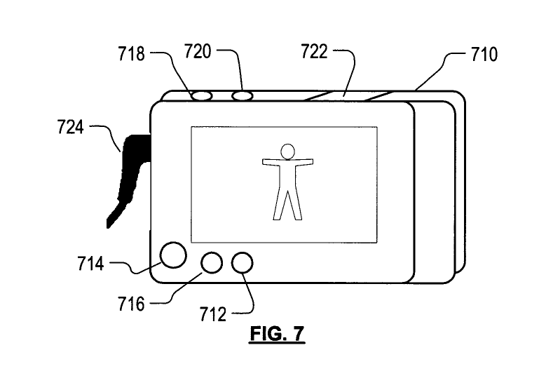

FIG. 7 depicts another portable memory device 710 incorporating features of the invention. In this embodiment, the device 710 is approximately the same size as a Type II PCMCIA device, which is 85.6 mm long, by 54 mm wide, by 5 mm thick. The display is approximately 35 mm by 50 mm OLED or suitable LCD. The device 710 features several operator controls including a ‘Power’ button 712, a four way toggle button 714, and a ‘Select’ button 716. Volume and tone controls 718 and 720, respectively, and a battery slot 722, are disposed on the top side of the device 710. There is also a headset (headset plug 724 is shown) so that the operator can listen to any accompanying audio associated with the stored digital images or video.

The device 710 can be attached/removed from a standard digital camera or digital video camcorder or inserted into a PC device such as a Laptop or PDA for storage of digital images, stills or video. Once removed from its host, the device 710 can be used as a standalone device for viewing, sharing, or exchanging images, video, presentations, or other digital content. In an alternative embodiment, the device 710 can be attached to a digital personal video recorder, (PVR) such as a TiVo or UltimateTV device, or an onboard entertainment systems (OES) found in automobiles, airplanes and boats. Operator selected video can be saved to the PVR and then removed or detached for viewing while away from the home.

FIG. 10 depicts yet another portable memory device 1010 incorporating features of the invention. It is similar to that of FIG. 7, except in FIG. 10 the image display occupies the entire major surface of the card-like device. Controls, if any, in various embodiments can be located on the back or on an edge (see buttons 1012) if the card has sufficient thickness. In other embodiments, the display is a touch screen and controls such as 1014 may appear only on the touch screen display. An effect of filling the entire major surface of the device with the display is that the device can be given a look and feel that is virtually the same as an ordinary photographic print. As shown in the figure, it can be handled and passed around in much the same familiar manner. In alternative embodiments, the display fills the entire major surface of the device except for a narrow border, and the frame is narrow enough to maintain the look and feel of an ordinary photographic print. Preferably, the frame on each side of the display is no wider than ¼″ for a card size of 4×6″, or 1/16 of the size of the minor dimension of the image surface of the card.

GPS/Dynamic Map Embodiment.

By incorporating a miniature Global Positioning Satellite (GPS) antenna via an external electrical jack, the actual location of the user with this device can be determined and graphically superimposed upon a digital map database, stored internally. As the user moves from one geographic location to another, the current location can be calculated in real time using standard latitude/longitude calculations derived from the GPS satellite data and drawn over the map database using, for example, standard NEMA interfaces and Geographic Information Systems (GIS) software. Geographic map databases are commercially available from a variety of sources for any geographic location including TeleAtlas, Navigation Technologies, and GDT to name a few.

Referring to FIG. 1, the external GPS antenna is connected to the memory display device via the Host Interface 1 and the I/O Control Unit 12. The GPS antenna can be internal in various embodiments. Typically but not necessarily, it is separate from any other included RF antenna. Upon selection of the ‘Geolocate’ function by the user via the User Interface 8 and the display 5, the digital control unit 2 retrieves the necessary control and configuration parameters stored digitally in the EEPROM 2a, and transmits them to the Timing & Control unit 7 and the I/O Control Unit 12 via internal address and data buses. Upon receipt and execution of parameter variables, these elements commence functioning in accordance with the GPS antenna manufacturer's specifications. The Digital Control Unit 2 directs the stream of antenna data from the I/O Control Unit 12 to RAM 2b. Latitude and longitude data is extracted from the data stream through the execution of the geolocation algorithm recommended by the specific GPS antenna manufacturer. Following each calculation, latitude and longitude data points are plotted on top of the user selected map database using a video overlay feature incorporated into the Display Controller 6. The precise location of the plot is determined by comparing the latitude and longitudinal range of the map database and calculating Cartesian-type (X-Y) coordinates for the display 5. The plot can be refreshed each time a new geolocation calculation is completed resulting in a different display coordinate set.

Other Capabilities

While the portable device 210 so far has been described primarily with respect to its image handling capabilities, it will be appreciated that, like other removable memory devices that do not include a display 5, other types of data aside from image data can also be written, read and manipulated on the portable memory device 210. For example, a host may store and retrieve word processing documents in the memory 212 of the memory device 210. In an embodiment, the portable memory device 210 has the capability in standalone mode to display the word processing documents on the display 5, and optionally to manipulate them. In another embodiment, a host may store and retrieve audio files in the memory 212 on the portable memory device 210. Such audio files might include an audio track for a video clip in the portable memory device 210, or an audio description associated with a still image in the portable memory device 210. Such audio files might also music, such as might be contained in an MP3 file. If the device 210 is designed to be able to play audio files in standalone mode, then typically it would include either a flat speaker (not shown) and/or a headphone jack 220. The device 210 can also include the capability of articulating textual information in a word processing document, a feature which would also make use of such a speaker or headphone jack.

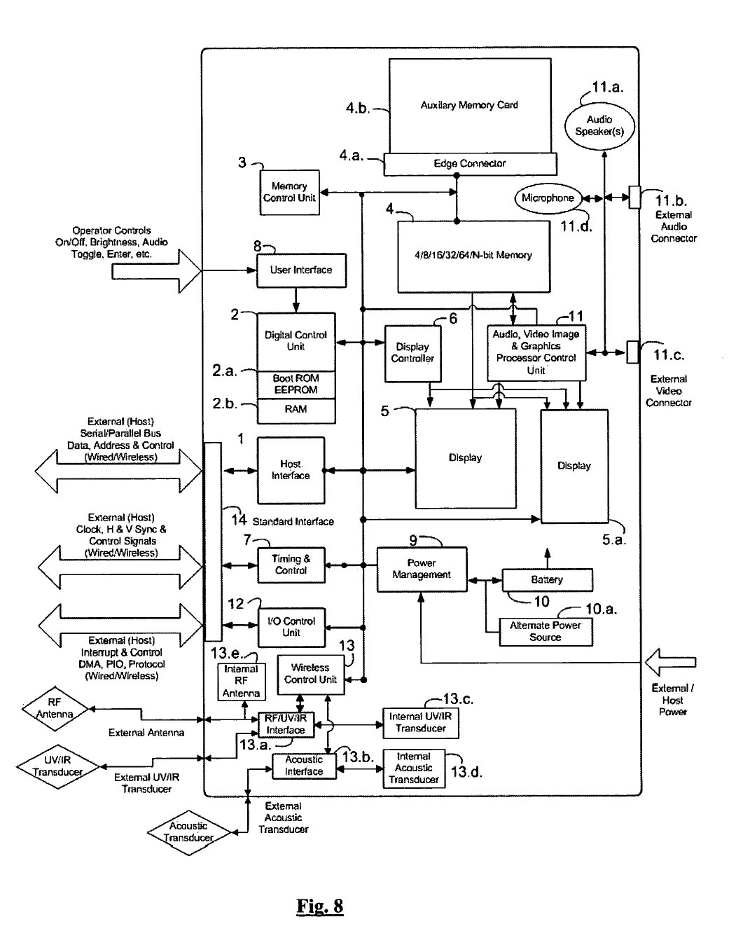

FIG. 8 illustrates an alternate embodiment of the invention. This embodiment permits additional memory expansion, memory device 4.b., via connector 4.a. which can be either a mechanical connector, IR, or wireless utilizing the wireless control unit 13 and interface 13.a. This memory device can be a standard module generally available for PCs, cell phones, hand-held electronic devices such as digital cameras and Palm Pilot branded personal digital assistants (PDAs, for example, but may also be a unique proprietary design. The external memory device may be blank, containing no additional programs or controls, or it may be pre-programmed, containing pre-loaded software or logic instructions, permitting new operational features or functionality such as playback and display formats or algorithms, for example. These instruction sets or software routines may be resident only on the auxiliary memory card 4.b. or can be used to re-program the Boot ROM/EEPROM 2.a., as is the case when a manufacturer sends software update modules to its customers.

The audio video and graphics processor 11 has audio outputs permitting connection to internal speakers 11.a., or external device via connector 11.b. An internal microphone 11.d. can also be connected to the audio video and graphics processor 11 or to an external device via connector 11.b. The processor 11 can also manage and control a plurality of internal displays, of at least one 5 or more 5.a., or external displays via external connector 11.c. This external connector 11.c. can be based upon industry standards such as S-VHS, SCART, RCA, etc., or be proprietary based.

An alternate power source 10.a. such as a solar cell can be readily incorporated into an embodiment of the present invention. In this embodiment, the power management function 9 monitors the voltage output of the alternate power source 10.a. In the event of a detected voltage level falling below operational requirements, the power management function 9 automatically switches power sources and begins to draw power from the battery 10.

Data input, output and overall device control can be performed internally or externally. Externally, this can be accomplished electrically by either mechanical (wired) or wireless means. Wireless connectivity to data and control is accomplished through the wireless control unit 13. Depending on a manufacturers preferences, either internal or external interfaces to a plurality of, but at least one, wireless interfaces such as, but not limited to, RF/UV/IR 13.a., and acoustic 13.b. These interfaces are further connected to either external or internal transducers such as an RF antenna 13.e., UV/IR 13.c., or Acoustic 13.d., for example.

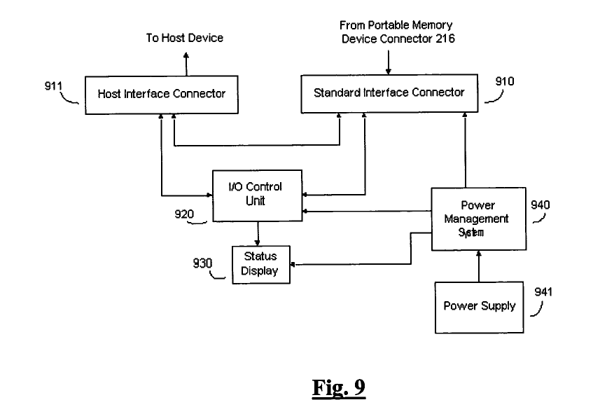

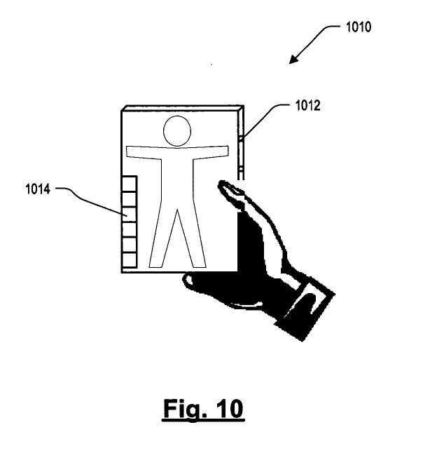

FIG. 9 depicts a block diagram of desktop power cradle assembly 230 that provides power to the portable memory device 210 and also facilitates communication with a Host, if attached. Standard Interface Connector 910 is identical to Host connector 232 or 234. Host Connector 911 can be any standard connector such as a USB or IEEE 1394 Firewire, Ethernet. Data is transferred between the Portable Memory Device 210 and a Host device under the control of I/O Control Unit 920, which continuously monitors the control signals from both the Host and the Memory Device. Power Management System 940 routes conditioned and regulated power to the Portable Memory Device via connector 910. Status Display 940 provides status of data transfer, communication between any attached Host device and Portable Memory device and power management.

As used herein, a given signal, event or value is “responsive” to a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same as the predecessor signal, event or value, this is merely a degenerate case in which the given signal, event or value is still considered to be “responsive” to the predecessor signal, event or value. “Dependency” of a given signal, event or value upon another signal, event or value is defined similarly.

The foregoing description of preferred embodiments of the present invention has been provided for the purposes of illustration and description. It is not intended to be exhaustive or to limit the invention to the precise forms disclosed. Obviously, many modifications and variations will be apparent to practitioners skilled in this art. In particular, and without limitation, any and all variations described, suggested or incorporated by reference in the Background section of this patent application are specifically incorporated by reference into the description herein of embodiments of the invention. The embodiments described herein were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A portable memory device comprising a substrate supporting:
a first memory;
a display;
a communications interface for establishing a user-severable communication link between the memory device and a plurality of different hosts at different times; and
a controller operable in response to user input to:
store in the memory an image received from a first one of the hosts via the communication link while the portable device is in communication with the first host,
render on the display an image represented in a file in the memory at least while the portable device is not in communication with any host, and
transform an image in the memory from a first image file format to a second image file format,
wherein the portable memory device fits within a bounding box having first and second parallel surfaces separated by no more than 10.5 mm.

2. A device according to claim 1, wherein the first and second parallel surfaces are separated by no more than approximately 5.0 mm.

3. A device according to claim 1, wherein at least one of the hosts is physically larger than the memory device,
further comprising a mounting system for rigidly attaching the memory device to each of the hosts at different times.

4. A device according to claim 1, wherein the controller is further operable to:
determine a second image file format suitable for a second one of the hosts, and
communicate the image to the second host via the communication link according to the second image file format while the portable device is in communication with the second host.

5. A device according to claim 1, wherein the controller is further operable in response to user input to transfer to the first host via the communication link an image from the memory while the memory device is in communication with the first host.

6. A device according to claim 1, wherein the controller is further operable in response to user input to transfer to a second one of the hosts via the communication link an image from the memory while the memory device is in communication with the second host, the second host being different from the first host.

7. A device according to claim 1, wherein the controller is further operable in response to user input to receive from the first host via the communication link a first image according to a first image file format for storage in the memory while the memory device is in communication with the first host,
and wherein the controller is further operable in response to user input to transfer to a second one of the hosts via the communication link the first image in a second image file format while the memory device is in communication with the second host, the second host being different from the first host and the second image file format being different from the first image file format.

8. A device according to claim 1, wherein the controller is further operable to render on the display an image from the first host while the memory device is in communication with the first host.

9. A device according to claim 8, wherein the controller is operable such that when operated to render on the display an image from the first host while the memory device is in communication with the first host, the image bypasses the memory.

10. A device according to claim 1, wherein the display comprises a member of the group consisting of an LCD display, polymer with photoresist properties, a plasma display an OLED display and a cholesteric display.

11. A device according to claim 1, wherein the display comprises a touch screen.

12. A device according to claim 1, wherein the communication link is a member of the group consisting of wired, wireless, magnetic, and infrared communication links.

13. A device according to claim 1, wherein the plurality of different hosts includes at least two hosts which are members of the group including but not limited to a personal computer, a PDA, a cellular telephone, a set top box, a TIVO device, and a digital camera.

14. A device according to claim 1, wherein the first host comprises a digital camera.

15. A device according to claim 1, further comprising a mechanical interface for rigidly attaching the memory device to a plurality of different hosts at different times.

16. A device according to claim 15, wherein the mechanical interface is such that attachment of the device to a particular host also enables the communication link between the device and the particular host, and detachment of the device to the particular host also severs the communication link between the device and the particular host.

17. A device according to claim 1, wherein the communications interface includes a first connector disposed along an edge of the device,
wherein a particular one of the hosts includes a slot sized to receive the device and having a second connector adapted to mate with the first connector when the device is inserted into the slot.

18. A device according to claim 1, further comprising a particular one of the hosts which includes a slot for receiving and holding a plurality of the memory devices simultaneously.

19. A device according to claim 18, wherein the communications interface on each of the memory devices includes a respective first connector disposed along an edge of the respective memory device,
and wherein the slot includes a respective second connector adapted to mate with the respective first connector of each one of the memory devices inserted into the slot.

20. A device according to claim 18, wherein the particular host is operable to write an image, in response to a single user-commit, to all the memory devices then held in the slot.

21. A device according to claim 18, wherein the particular host is operable to write an image to a subset of the memory devices then held in the slot in dependence upon user selection input.

22. A device according to claim 18, further comprising a cartridge for receiving the plurality of the memory devices simultaneously, the slot in the particular host being for receiving the cartridge.

23. A device according to claim 22, further comprising a mechanical structure to hold, release, and eject the cartridge from said body.

24. A device according to claim 1, wherein the memory, the display, the communications interface and the controller are all rigidly attached to the substrate.

25. A device according to claim 24, wherein the substrate is rigid.

26. A device according to claim 24, wherein the substrate is flexible.

27. A device according to claim 1, wherein the controller comprises a general purpose processor and program memory.

28. A device according to claim 27, wherein the controller comprises a plurality of processors including the general purpose processor.

29. A device according to claim 27, wherein the controller is further operable to write into the program memory program code received from an external source.

30. A device according to claim 27, wherein the program memory is distinct from the first memory.

31. A device according to claim 27, wherein the program memory includes program code operable to perform the operation of transforming an image from a first image file format to a second image file format.

32. A device according to claim 1, wherein a second one of the hosts is operable to form a plurality of sequential individual images, wherein the controller is further operable to:
store in the memory the plurality of sequential images; and
render the sequential images sequentially on the display as a movie.

33. A device according to claim 1, wherein a second one of the hosts is operable to form a movie, wherein the controller is further operable to:
store the movie in the memory; and
render on the display a selected image from the movie as a still image.

34. A device according to claim 1, wherein a second one of the hosts is operable to form a plurality of sequential individual images, wherein the controller is further operable to:
receive the plurality of sequential images;
convert the plurality of sequential images into a video file; and
store the video file in the first memory.

35. A device according to claim 1, wherein a second one of the hosts is operable to form a video file, and wherein the controller is operable to:
store the video file in the first memory;
display the video file on the display; and
in response to user input, capture an image frame of the video file and store it as an image file in the first memory.

36. A device according to claim 1, wherein the controller is further operable to perform, in response to user input, file management functions on files stored in the memory.

37. A device according to claim 1, wherein the portable memory device further comprises an audio feature including a member of the group consisting of one or more speakers and an audio jack, and wherein the controller is further operable in response to user input to:
store in the memory a sound received from one of the hosts via the communication link while the portable device is in communication with the first host, and
play via the audio feature a sound represented in a file in the memory at least while the portable device is not in communication with any host.

38. A device according to claim 1, wherein the controller is further operable in response to user input to:
store in the memory a moving image received from one of the hosts via the communication link while the portable device is in communication with the first host, and
play via the display a moving image represented in a file in the memory at least while the portable device is not in communication with any host.

39. A device according to claim 1, wherein the portable memory device further comprises an audio feature including a member of the group consisting of a speaker and an audio jack, and wherein the controller is further operable in response to user input to:
store in the memory an image with associated sounds received from one of the hosts via the communication link while the portable device is in communication with the first host,
render the image on the display at least while the portable device is not in communication with any host, and
play the associated sounds via the audio feature while rendering the image on the display.

40. A device according to claim 1, wherein the controller is further operable in response to user input to:
store in the memory a document received from one of the hosts via the communication link while the portable device is in communication with the first host, and
render the document on the display at least while the portable device is not in communication with any host.

41. A device according to claim 1, wherein the portable memory device further comprises an audio feature including a member of the group consisting of a speaker and an audio jack, and wherein the controller is further operable in response to user input to:
store in the memory textual information received from one of the hosts via the communication link while the portable device is in communication with the first host, and
articulate the textual information via the audio feature at least while the portable device is not in communication with any host.

42. A device according to claim 1, wherein the portable memory device comprises, for providing the user input, a member of the group consisting of a touch screen, a button, a switch, and a receiver for a remote control device.

43. A device according to claim 1, wherein the portable memory device further comprises a speech recognition feature for providing the user input.

44. A device according to claim 1, wherein the controller is further operable to:
determine a geolocation of the portable memory device; and
render on the display a map which includes a visible marking of the geolocation.

45. A portable memory device comprising a substrate supporting:
a memory;
a display;
a communications interface for establishing a user-severable communication link between the memory device and a plurality of different hosts at different times, at least one of the hosts being physically larger than the memory device;
a mounting system for rigidly attaching the memory device to each of the host at different times; and
a controller operable in response to user input to:
store in the memory an image received from a first one of the hosts via the communication link while the portable device is in communication with the first host,
render on the display an image represented in a file in the memory at least while the portable device is not in communication with any host, and
transform an image in the memory from a first image file format to a second image file format.

46. A device according to claim 45, wherein the mounting system is independent of the communications interface.

47. A device according to claim 46, wherein the mounting system comprises at least one of a surface of hooks or a surface of loops for a hook-and-loop fastening system.

48. A device according to claim 45, wherein the mounting system and the communications interface both comprise a rigid an electrical connector for mating with a corresponding connector on each of the hosts at different times.

49. A device according to claim 45, wherein the controller is further operable to:
determine a second image file format suitable for a second one of the hosts, and
communicate the image to the second host via the communication link according to the second image file format while the portable device is in communication with the second host.

50. A device according to claim 45, wherein the controller is further operable in response to user input to transfer to the first host via the communication link an image from the memory while the memory device is in communication with the first host.

51. A device according to claim 45, wherein the controller is further operable in response to user input to transfer to a second one of the hosts via the communication link an image from the memory while the memory device is in communication with the second host, the second host being different from the first host.

52. A device according to claim 45, wherein the controller is further operable in response to user input to receive from the first host via the communication link a first image according to a first image file format for storage in the memory while the memory device is in communication with the first host,
and wherein the controller is further operable in response to user input to transfer to a second one of the hosts via the communication link the first image in a second image file format while the memory device is in communication with the second host, the second host being different from the first host and the second image file format being different from the first image file format.

53. A device according to claim 45, wherein the controller is further operable to render on the display an image from the first host while the memory device is in communication with the first host.

54. A device according to claim 53, wherein the controller is operable such that when operated to render on the display an image from the first host while the memory device is in communication with the first host, the image bypasses the memory.

55. A device according to claim 45, wherein the communication link is a member of the group consisting of wired, wireless, magnetic, and infrared communication links.

56. A device according to claim 45, wherein the first host comprises a digital camera.

57. A device according to claim 45, wherein the communications interface includes a first connector disposed along an edge of the device,
wherein a particular one of the hosts includes a slot sized to receive the device and having a second connector adapted to mate with the first connector when the device is inserted into the slot.

58. A device according to claim 45, further comprising a particular one of the hosts which includes a slot for receiving and holding a plurality of the memory devices simultaneously.

59. A device according to claim 58, wherein the communications interface on each of the memory devices includes a respective first connector disposed along an edge of the respective memory device,
and wherein the slot includes a respective second connector adapted to mate with the respective first connector of each one of the memory devices inserted into the slot.

60. A device according to claim 58, wherein the particular host is operable to write an image, in response to a single user-commit, to all the memory devices then held in the slot.

61. A device according to claim 58, wherein the particular host is operable to write an image to a subset of the memory devices then held in the slot in dependence upon user selection input.

62. A device according to claim 58, further comprising a cartridge for receiving the plurality of the memory devices simultaneously, the slot in the particular host being for receiving the cartridge.

63. A device according to claim 45, wherein the memory, the display, the communications interface and the controller are all rigidly attached to the substrate.

64. A device according to claim 63, wherein the substrate is rigid.

65. A device according to claim 45, wherein the controller comprises a general purpose processor and program memory.

66. A device according to claim 65, wherein the controller comprises a plurality of processors including the general purpose processor.

67. A device according to claim 65, wherein the program memory includes program code operable to perform the operation of transforming an image from a first image file format to a second image file format.

68. A device according to claim 45, wherein a second one of the hosts is operable to form a plurality of sequential individual images, wherein the controller is further operable to:
store in the memory the plurality of sequential images; and
render the sequential images sequentially on the display as a movie.

69. A device according to claim 45, wherein a second one of the hosts is operable to form a plurality of sequential individual images, wherein the controller is further operable to:
receive the plurality of sequential images;
convert the plurality of sequential images into a video file; and
store the video file in the first memory.

70. A device according to claim 45, wherein a second one of the hosts is operable to form a video file, and wherein the controller is operable to:
store the video file in the first memory;
display the video file on the display; and
in response to user input, capture an image frame of the video file and store it as an image file in the first memory.

71. A device according to claim 45, wherein the portable memory device further comprises an audio feature including a member of the group consisting of a speaker and an audio jack, and wherein the controller is further operable in response to user input to:
store in the memory a sound received from one of the hosts via the communication link while the portable device is in communication with the first host, and
play via the audio feature a sound represented in a file in the memory at least while the portable device is not in communication with any host.

72. A device according to claim 45, wherein the portable memory device further comprises an audio feature including a member of the group consisting of a speaker and an audio jack, and wherein the controller is further operable in response to user input to:
store in the memory textual information received from one of the hosts via the communication link while the portable device is in communication with the first host, and
articulate the textual information via the audio feature at least while the portable device is not in communication with any host.

73. A device according to claim 45, wherein the controller is further operable to:
determine a geolocation of the portable memory device; and
render on the display a map which includes a visible marking of the geolocation.

74. A portable memory device comprising a substrate supporting:
a memory;
a display;
a communications interface for establishing a user-severable communication link between the memory device and a plurality of different hosts at different times; and
a controller operable to:
store in the memory an image received from a first one of the hosts via the communication link according to a first image file format while the portable device is in communication with the first host,
render on the display an image represented in a file in the memory at least while the portable device is not in communication with any host,
determine a second image file format suitable for a second one of the hosts, and
communicate the image to the second host via the communication link according to the second image file format while the portable device is in communication with the second host.

75. A device according to claim 74, wherein the controller is operable further to transform an image in the memory from a first image file format to the second image file format for in response to determining the second image file format.

76. A device according to claim 74, wherein the controller is operable to determine the second image file format by interrogating the second host while the portable device is in communication with the second host.

77. A device according to claim 74, wherein the controller is operable to determine the second image file format in dependence upon information received from the second host indicating a device type.

78. A device according to claim 74, wherein the controller is further operable in response to user input to receive from the first host via the communication link a first image according to a first image file format for storage in the memory while the memory device is in communication with the first host,
and wherein the controller is further operable in response to user input to transfer to a second one of the hosts via the communication link the first image in a second image file format while the memory device is in communication with the second host, the second host being different from the first host and the second image file format being different from the first image file format.

79. A device according to claim 74, wherein the controller is further operable to render on the display an image from the first host while the memory device is in communication with the first host.

80. A device according to claim 74, wherein the communication link is a member of the group consisting of wired, wireless, magnetic, and infrared communication links.

81. A device according to claim 74, wherein the plurality of different hosts includes at least two hosts which are members of the group consisting of a personal computer, a PDA, a cellular telephone, a set top box, a TIVO device, and a digital camera.

82. A device according to claim 74, wherein the communications interface includes a first connector disposed along an edge of the device,
wherein a particular one of the hosts includes a slot sized to receive the device and having a second connector adapted to mate with the first connector when the device is inserted into the slot.

83. A device according to claim 74, further comprising a particular one of the hosts which includes a slot for receiving and holding a plurality of the memory devices simultaneously.

84. A device according to claim 83, further comprising a cartridge for receiving the plurality of the memory devices simultaneously, the slot in the particular host being for receiving the cartridge.

85. A device according to claim 74, wherein the memory, the display, the communications interface and the controller are all rigidly attached to the substrate.

86. A device according to claim 74, wherein a second one of the hosts is operable to form a plurality of sequential individual images, wherein the controller is further operable to:
store in the memory the plurality of sequential images; and
render the sequential images sequentially on the display as a movie.

87. A device according to claim 74, wherein a second one of the hosts is operable to form a video file, and wherein the controller is operable to:
store the video file in the first memory;
display the video file on the display; and
in response to user input, capture an image frame of the video file and store it as an image file in the first memory.

88. A device according to claim 74, wherein the portable memory device further comprises an audio feature including a member of the group consisting of a speaker and an audio jack, and wherein the controller is further operable in response to user input to:
store in the memory a sound received from one of the hosts via the communication link while the portable device is in communication with the first host, and
play via the audio feature a sound represented in a file in the memory at least while the portable device is not in communication with any host.

89. A device according to claim 74, wherein the controller is further operable in response to user input to:
store in the memory a moving image received from one of the hosts via the communication link while the portable device is in communication with the first host, and
play via the display a moving image represented in a file in the memory at least while the portable device is not in communication with any host.

90. A device according to claim 74, wherein the portable memory device further comprises an audio feature including a member of the group consisting of a speaker and an audio jack, and wherein the controller is further operable in response to user input to:
store in the memory textual information received from one of the hosts via the communication link while the portable device is in communication with the first host, and
articulate the textual information via the audio feature at least while the portable device is not in communication with any host.

91. A device according to claim 74, wherein the controller is further operable to:
determine a geolocation of the portable memory device; and
render on the display a map which includes a visible marking of the geolocation.

92. A portable memory device comprising a substrate supporting:
a display;
a communications interface for establishing a user-severable communication link between the memory device and a plurality of different hosts at different times;
a receptacle for receiving a further memory device removable from the portable memory device; and
a controller operable in response to user input to:
store in memory of the further memory device an image received from a first one of the hosts via the communication link while the portable device is in communication with the first host and the further memory device is in communication with the portable memory device,
render on the display an image represented in a file in the memory of the further memory device at least while the portable device is not in communication with any host, and
transform an image in the memory of the further memory device from a first image file format to a second image file format,
wherein the portable memory device fits within a bounding box having first and second parallel surfaces separated by no more than 10.5 mm.

93. A method for sharing an image, for use with a portable memory device having a substrate supporting a memory, a display and a controller, comprising the steps of:
establishing communication between the memory device and a first host;
while the first host is in communication with the memory device, capturing an image through the first host and into the memory of the memory device, the image being communicated to the memory device according to a first file format;
removing the memory device from communication with the first host;
establishing communication between the memory device and a second host;
determining from the second host a second image file format suitable for the second host;
while the second host is in communication with the memory device and the first host is not in communication with the memory device, transferring the image from the memory to the second host in the second image file format; and
rendering the image on the display of the memory device while the memory device is not in communication with any host.

94. A method according to claim 93, further comprising the step of transforming the image from the first file format to the second file format while the memory device is not in communication with the first host.

95. A method according to claim 93, wherein the step of determining comprises the step of interrogating the second host.

96. A method according to claim 93, wherein the step of determining comprises the step of determining the second image file format in dependence upon information received from the second host indicating a device type.

97. A method according to claim 93, wherein the memory device fits within a bounding box having first and second parallel surfaces separated by no more than 10.5 mm.

98. A method according to claim 93, wherein the memory device fits within a bounding box having first and second parallel surfaces separated by no more than approximately 5.0 mm.

99. A method according to claim 93, wherein the memory device includes a receptacle for a further removable memory device, wherein the step of capturing an image comprises the step of storing the image in the further removable memory device, further comprising the steps of::
attaching the further removable memory device to the receptacle prior to the step of capturing an image; and
removing the further removable memory device after the step of transferring the image to the second host.

100. A portable memory device comprising a substrate supporting:
a first memory;
a display;
a communications interface for establishing a user-severable communication link between the memory device and a plurality of different hosts at different times; and
a controller operable in response to user input to:
store in the memory an image received from a first one of the hosts via the communication link while the portable device is in communication with the first host, and
render on the display an image represented in a file in the memory at least while the portable device is not in communication with any host,
wherein the portable memory device fits within a bounding box having first and second parallel surfaces separated by no more than 10.5 mm,
and wherein the display fills a major surface of the device.

101. A device according to claim 100, wherein said controller is operable further to transform an image in the memory from a first image file format to a second image file format.

102. A portable memory device comprising a substrate supporting:
a first memory;
a display;
a communications interface for establishing a user-severable communication link between the memory device and a plurality of different hosts at different times; and
a controller operable in response to user input to:
store in the memory an image received from a first one of the hosts via the communication link while the portable device is in communication with the first host, and
render on the display an image represented in a file in the memory at least while the portable device is not in communication with any host,
wherein the portable memory device fits within a bounding box having first and second parallel surfaces separated by no more than 10.5 mm,
wherein the device has a major surface having major and minor dimensions,
and wherein the display fills said major surface except for a border no wider than 1/16 the size of said minor dimension.

103. A device according to claim 102, wherein said controller is operable further to transform an image in the memory from a first image file format to a second image file format.
